(19) United States
(12) Patent Application Publication
(10) Pub. No.: US 2016/0339537 A1
(43) Pub. Date: Nov. 24, 2016

(54) Forming a Casing of an Electronics Device

(71) Applicant: HEWLETT-PACKARD DEVELOPMENT COMPANY, L.P., Houston, TX (US)

(72) Inventors: Kuan-Ting Wu, Taipei City (TW); YU-CHUAN KANG, Taipei City (TW)

(21) Appl. No.: 15/111,533

(22) PCT Filed: Feb. 12, 2014
(86) PCT No.: PCT/US2014/015993

§ 371 Date: Jul. 14, 2016

(51) Int. Cl. B23K 20/02; B21D 22/02; B23K 20/16; B21D 51/16

(52) U.S. Cl. CPC B23K 20/023; B21D 51/16; B21D 22/022; B23K 20/16; B23K 2201/36

(57) ABSTRACT

A method of forming a casing of an electronic device is described in which heat and pressure are applied to a metal substrate and a metal layer in a molding device. The metal substrate and the metal layer are molded into a shape of the casing. At the same time, an intermediate phase between the metal substrate and the metal layer is formed by inter-diffusion bonding.

### BACKGROUND

Devices such as mobile phones, tablets and portable (e.g. laptop or palm) computers are generally provided with a casing. The casing typically provides a number of functional and physical features.

Increasingly, consumers are also interested in the aesthetic properties of the casing. Furthermore, as devices such as mobile phones, tablets and portable computers are typically designed for hand-held functionality, consumers may also consider the weight of the device.

### BRIEF DESCRIPTION OF DRAWINGS

By way of non-limiting examples, device casings and processes of manufacturing such casinos according to the present disclosure will be described with reference to the following drawings in which

FIGS. 1A-1C are sectional side views showing an example of the formation of an intermediate phase by inter-diffusion bonding

FIG. 2 is a flow diagram illustrating an example of a method of forming a casing of an electronics device

FIG. 3 is a sectional side view of an example of a molding device pre-loaded with materials to be formed into a casing of an electronics device

FIG. 4 is a sectional side view of the molding device of FIG. 3 in the process of forming a casing of an electronics device

FIG. 5 is a perspective view of an example of a casing produced by the molding device of FIGS. 3 and 4

FIG. 6 is a sectional side view of another molding device in the process of forming a casing for an electronics device

FIG. 7 is a sectional top view of an example of a metal casing produced by the molding device of FIG. 6

### DETAILED DESCRIPTION

The present disclosure describes a method of forming a casing of an electronics device. For example, placing a metal substrate and a metal layer into a molding device, and applying heat and pressure to the parts of the molding device. The shape of the casing formed by this method is determined by the structure of the internal cavity formed by the mold parts.

The application of heat and pressure during the molding process allows for the formation of an intermediate phase, formed by inter-diffusion bonding, at the contact points of the metal substrate and the metal layer. This intermediate phase bonds the metal layer to the substrate surface and forming a coating of the metal layer thereon.

The use of a single step processing method to both mold the metal substrate while also coating the substrate with metal layer is more economical and increases production speed when compared to processes having multiple stages.

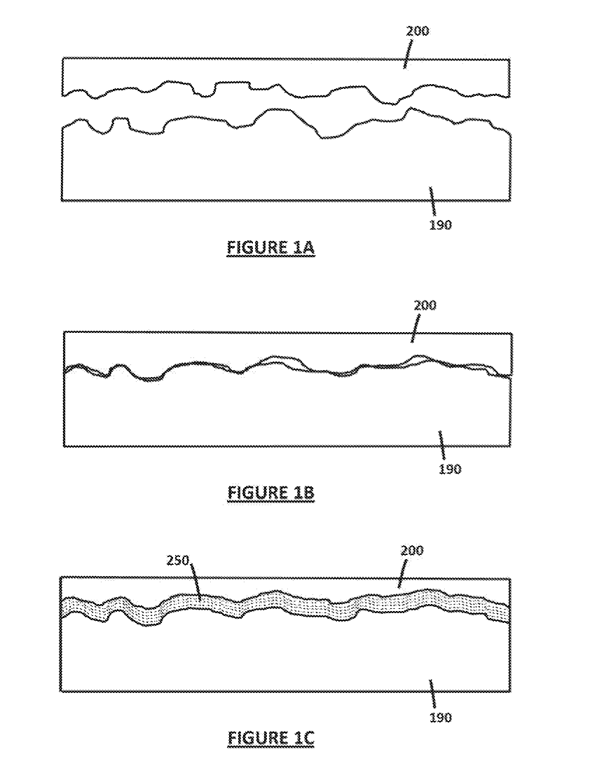

Referring to FIGS. 1A-1C, inter-diffusion bonding occurs where the surfaces of two metals, in this case a metal substrate 190 and metal layer 200, are pressed together under elevated temperature and pressure. As the metals are brought into contact, asperities in the form of micro-structures and micro-voids on the metal surfaces contact at the microscopic level and plastically deform. As these asperities deform, they interlink forming an interface between the two surfaces, as shown in FIG. 1B.

As heat and pressure are continued to be applied, the metal atoms of the two metals migrate (i.e. “diffuse”) across the interface of the abutting surfaces of the two metals, thus forming an intermediate phase 250. This intermediate phase 250, shown in FIG. 1C, comprises metal atoms from both the metal substrate and the metal layer.

As the joining of the two metals by inter-diffusion bonding relies on the intermingling of their own particles, no additional reactants or binders are required and, thus no additional weight is added during the molding arid bonding of the metal substrate and metal layer.

By coating a reactive metal substrate with a metal layer in the above manner, further treatments to the bonded metal layer surface are then available that are not suitable or possible for use on the original metal substrate, for example due to the metal substrate's high reactivity, high porosity and other health and safety considerations. This method allows the use of material whose properties are suitable as the base material for the formation of, for example, a casing for an electronics device, which are attractive for their strength and light weight, by also providing a metal layer coating that can be treated to provide visual, tactile and textural properties.

For example, the metal substrate may be magnesium or its alloys. Use of magnesium in industry is limited due to a number of undesirable properties such as its high reactivity, tendency towards being corroded, high-temperature creep properties and flammability. However, magnesium and its alloys, are strong, light weight and low density metals. These are particularly desirable properties for a casing of an electronics device. Furthermore, although magnesium can be significantly more expansive than other light metals, casting and other formation processes are easier, more economical and faster with magnesium than for other light metals, for example aluminium.

A number of magnesium alloys produce undesirable properties, however the addition of small amounts of aluminium, zinc and/or manganese can positively alter the physical properties of magnesium. For example, the addition of manganese can increase corrosion resistance, while the addition of aluminium and zinc, i.e. a magnesium-aluminium-zinc (MgAZ) alloy, promote precipitation hardening, resulting in an alloy with a strength-to-weight ratio comparable to those of certain aluminium alloys and alloy steels.

Another magnesium alloy could include a magnesium-lithium alloy. Whilst still maintaining some of the aforementioned undesirable properties, in that lithium is also highly reactive, magnesium-lithium alloys could be of suitable benefit for electronics device casings due to the minor addition of lithium improving the weight advantages of magnesium even further. For example, magnesium alloys containing around 10% lithium are approximately 45% less dense than aluminium and about 14% less dense than pure magnesium. However, due to the high reactivities of both magnesium and lithium, care is to be taken in their handling, formation and surface treatments.

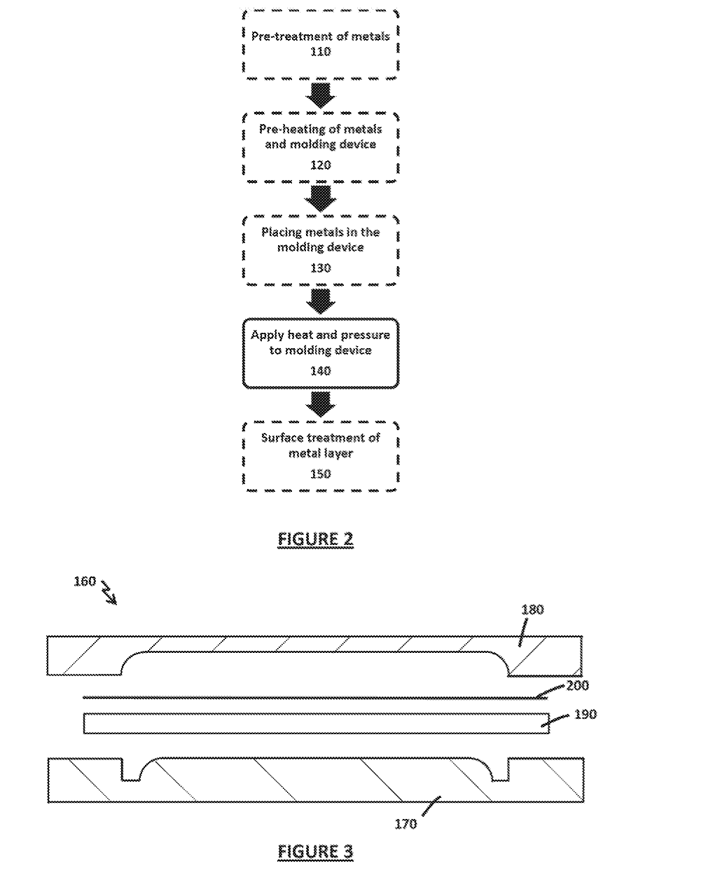

Referring to FIG. 2, a metal substrate 190 and a metal layer 200 may undergo pre-treatment 110, for example being machined to ensure as smooth a finish as economically viable and chemical treatments to keep the surfaces of the metal substrate and metal layer free of contaminants. These pre-treatments allow for the improving the area of surface contact between the metal substrate and the metal layer during the molding and bonding process.

The metal substrate may be, for example, a magnesium-lithium (MgLi) alloy having a thickness of 0.3-100 mm, and more particularly 0.5-5 mm. The metal layer may be, for example, a magnesium-aluminium-zinc (MgAZ) alloy having a thickness of 0.1-3 mm.

The metal layer 200 may be of any dimensions and shape to cover a desired surface area of the metal substrate 190. In one example, the metal layer 200 is of sufficient size to envelop the outer surface area of the metal substrate 190, providing a large contact area and, therefore, enhanced bonding ability between the metal substrate and metal layer.

Prior to introducing the metal substrate (190) and the metal layer 200 into the molding device, the metal substrate 190, the metal layer and the molding device may be pre-heated 120, typically to temperatures of between 150-700° C. This pre-heating allows for a reduced time and pressure requirement to achieve an intermediate layer of desired properties, thus improving manufacturing output.

Following any pre-treatment and pre-heating processes, the metal substrate 190 and the metal layer 200 are placed 130 into the molding device 160. The metal substrate 190 and the metal layer 200 then undergo a molding and bonding process (140) which includes the application of heat and pressure while the metal substrate and the metal layer are within the molding device 160.

Referring to FIG. 3, a molding device 160 is provided having a core mold 170 and a cavity mold 180. In one example, a metal substrate 190 is placed between the core mold 170 and the cavity mold 180, and a metal layer 200 is then placed between the metal substrate 190 and the cavity mold 180. However, any placement method that results in the surfaces of the metal substrate 190 and the metal layer 200 abutting within the molding device 160 can also be used.

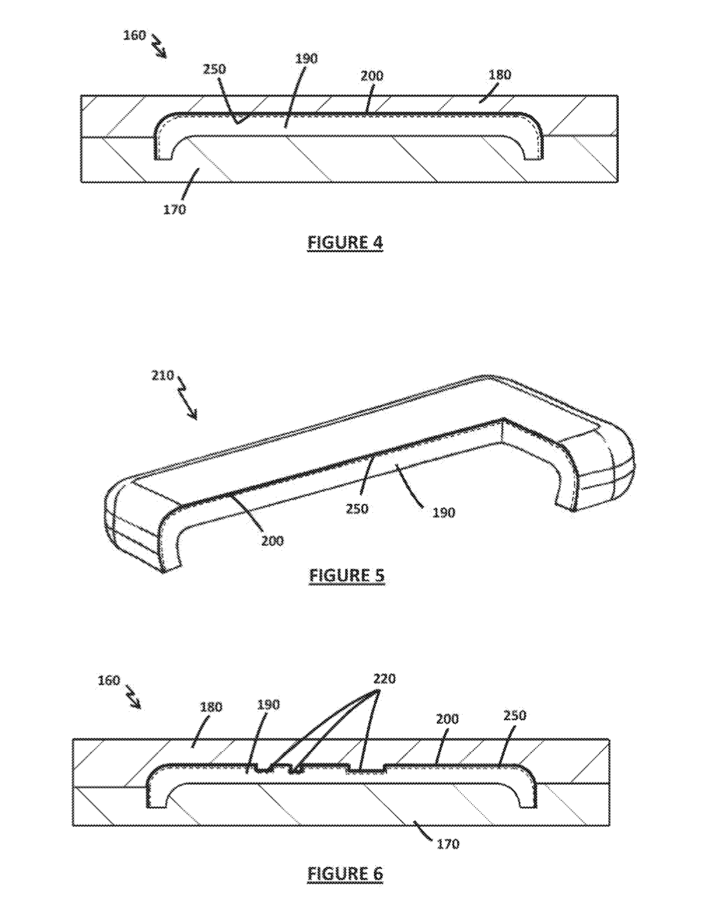

Once the metal substrate 190 and the metal layer 200 are placed 130 within the molding device 160, pressure and that are transmitted through the core and cavity molds 170, 180 to the metal substrate 190 and metal layer 200, as best seen in FIG. 4. Typical operating temperatures are in the order of 150-700° C., with a pressure of 35-60 kgw/mm² being applied to the metal substrate 190 and metal layer 200 within the molding device.

The metal substrate and metal layer are kept under pressure and heat for sufficient duration to allow the formation of an intermediate phase 250 by inter-diffusion bonding at the contact surfaces of the metal substrate 190 and the metal layer 200. The above described bonding and molding process typically taking less than 3 minutes.

The inner cavity shape, and thus the shape of the final product following the molding process, is dependent on the shapes of the internal surfaces of the core mold 170 and the cavity mold 180. Although a simple inner cavity mold is shown for the apparatus 160 of FIG. 4, resulting in the casing 210 of FIG. 5, it is possible to alter the inner surfaces of the molds 170, 180 to provide different shapes, textures and other features to the finished product.

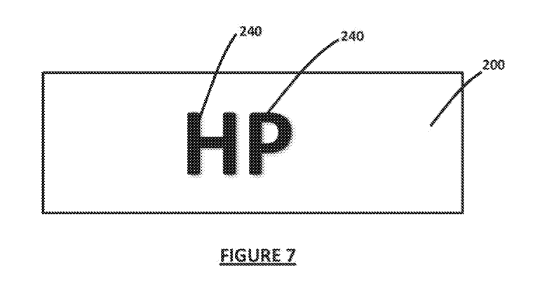

For example, a further possible molding device is provided at FIG. 6. In this apparatus, the cavity mold 180 has been adapted to include a number of protrusions 220 in order to stamp the outer surface of the metal layer 200. In this example, the inner surface of the cavity mold was adapted to stamp the letters “HP” 240 on to the final product, as shown in FIG. 7.

Referring again to FIG. 2, once molding under heat and pressure 130 is complete, the metal layer may undergo further surface treatments in order to provide desired visual, physical and tactile properties of the casing. Such treatments may include baking, electrochemical treatments (anodizing, micro-arc oxidation, electrophoretic deposition), dyeing, painting, spray coating, sputter costing, nano-coating, inkjet printing, 3D printing, chemical vapour deposition, electroplating and physical vapour deposition.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method of forming a casing of an electronics device, the method comprising
applying pressure and heat to a metal substrate and a metal layer in a molding device to form an intermediate phase between the distal substrate and the metal layer by inter-diffusion bonding and to shape the metal substrate and the metal layer into the casing.

2. The method according to claim 1, wherein the metal substrate is one of magnesium and magnesium alloy.

3. The method according to claim 1, wherein the metal layer is one of aluminium, an aluminum alloy and a magnesium-aluminium-zinc alloy.

4. The method according to claim 1, wherein the method further comprises, after applying pressure and heat, performing a surface treatment of the metal layer.

5. A casing for an electronics device, the casing comprising
a metal substrate in the shape of the casing,
a metal layer, and
an intermediate phase formed by inter-diffusional bonding between the metal substrate and the metal layer.

6. The casing according to claim 5, wherein the metal substrate is a magnesium-lithium alloy

7. The casing according to claim 5, wherein the metal layer is a magnesium-aluminium-zinc alloy.

8. The casing according to claim 5, wherein the metal substrate has a thickness of 0.5-5 mm.

9. The casing according to claim 5, wherein the metal layer has a thickness of 0.1-3 mm.

10. The casing according to claim 5, wherein the intermediate phase has a thickness of 3-10 μm.

10. A method of molding and coating a casing for an electron ids device, the method comprising
placing a metal substrate and a coat metal layer between a core mold part and a cavity mold part, and
applying pressure and heat to the core mold part and cavity mold part, such that an intermediate phase is formed by inter-diffusional bonding at points of contact between the metal substrate and the coat metal layer.

11. The method according to claim 10, wherein the metal substrate is a magnesium-lithium alloy.

12. The method according to claim 10, wherein the core and cavity molds have internal surfaces shaped to define the shape of the casing.

13. The method according to claim 12, wherein the internal surfaces of the core and cavity molds include protrusions and/or depressions to provide respective depressions and/or protrusions on the casing.

14. The method according to claim 10, wherein the method further comprises, after applying pressure and heat, performing a surface treatment of the metal layer.

15. The method according to claim 10, wherein the electronics device is a phone, tablet, portable computer or other electronics device.
